(19) United States
(12) Patent Application Publication
(10) Pub. No.: US 2024/0264011 A1
(43) Pub. Date: Aug. 8, 2024

(54) LOAD DETECTING DEVICE

(71) Applicant: Panasonic Intellectual Property Management Co., Ltd., Osaka (JP)

(72) Inventors: Yuta YAMAMOTO, Kyoto (JP); Hironobu UKITSU, Osaka (JP); Yuta MORIURA, Osaka (JP); Mitsutaka YAMAGUCHI, Gifu (JP)

(21) Appl. No.: 18/641,077

(22) Filed: Apr. 19, 2024

Related U.S. Application Data
(63) Continuation of application No. PCT/JP2022/035777, filed on Sep. 26, 2022.

(30) Foreign Application Priority Data
Oct. 27, 2021 (JP) 2021-175716

(51) Int. Cl. G01L 1/14

(52) U.S. Cl. CPC G01L 1/146

(57) ABSTRACT

A load detecting device includes: a load sensor including an element part; a first detection circuit configured to perform charging of a predetermined voltage and discharging of a charged voltage with respect to one electrode of the element part, and output a voltage of the element part in a charge period; a second detection circuit configured to, in parallel with the charging and discharging, perform discharging from the predetermined voltage and charging of the predetermined voltage with respect to another electrode of the element part, and output a voltage of the element part in a discharge period; and a control circuit configured to detect the capacitance in the element part, based on a differential voltage obtained by adding a voltage obtained by inverting a second detection voltage from the second detection circuit between the predetermined voltage and a ground, to a first detection voltage from the first detection circuit.

### CROSS REFERENCE TO RELATED APPLICATION

This application is a continuation of International Application No. PCT/JP2022/035777 filed on Sep. 26, 2022, entitled “LOAD DETECTING DEVICE”, which claims priority under 35 U.S.C. Section 119 of Japanese Patent Application No. 2021-175716 filed on Oct. 27, 2021, entitled “LOAD DETECTING DEVICE”. The disclosures of the above applications are incorporated herein by reference.

### BACKGROUND OF THE INVENTION

### Field of the Invention

The present invention relates to a load detecting device which detects a load, based on change in capacitance.

### Description of Related Art

Load sensors are widely used in the fields of industrial apparatuses, robots, vehicles, and the like. In recent years, in accordance with advancement of control technologies by computers and improvement of design, development of electronic apparatuses that use a variety of free-form surfaces such as those in human-form robots and interior equipment of automobiles is in progress. In association therewith, it is required to mount a high performance load sensor to each free-form surface.

International Publication No. WO2019/187516 discloses a device that detects capacitance in a capacitance-type sensor. In this device, charging voltage is applied to a sensor element via a resistor. Based on change in the voltage in a subsequent stage of the resistor after the application of the charging voltage, the capacitance in the sensor element is detected.

In the configuration as above, for example, when a metal or a dielectric body is present around the sensor element, noise may be superposed on the voltage in the subsequent stage of the resistor. In this case, the capacitance may fail to be accurately detected due to the superposed noise.

### SUMMARY OF THE INVENTION

A load detecting device according to a main aspect of the present invention includes: a load sensor including an element part in which capacitance changes in accordance with a load; a first detection circuit configured to perform charging of a predetermined voltage and discharging of a charged voltage with respect to one electrode of the element part, and output a voltage of the element part in a charge period; a second detection circuit configured to, in parallel with the charging and discharging in the first detection circuit, perform discharging from the predetermined voltage and charging of the predetermined voltage with respect to another electrode of the element part, and output a voltage of the element part in a discharge period; and a control circuit configured to detect the capacitance, based on a differential voltage obtained by adding a voltage obtained by inverting a second detection voltage outputted from the second detection circuit between the predetermined voltage and a ground, to a first detection voltage outputted from the first detection circuit.

In the load detecting device according to the present aspect, a voltage obtained by inverting the second detection voltage outputted from the second detection circuit between the predetermined voltage and the ground is added to the first detection voltage outputted from the first detection circuit. Accordingly, noises respectively superposed on the first detection voltage and the second detection voltage are canceled with each other. Therefore, in the differential voltage acquired through this, noise is suppressed. Therefore, based on this differential voltage, the capacitance according to the load on the element part can be accurately detected.

The effects and the significance of the present invention will be further clarified by the description of the embodiment below. However, the embodiment below is merely an example for implementing the present invention. The present invention is not limited to the description of the embodiment below in any way.

### BRIEF DESCRIPTION OF THE DRAWINGS

FIG. 1A is a perspective view schematically showing a base member and electrically-conductive elastic bodies set on the upper face of the base member, according to an embodiment;

FIG. 1B is a perspective view schematically showing a state where conductor wires are set on the structure in FIG. 1A, according to the embodiment;

FIG. 2A is a perspective view schematically showing a state where threads are set on the structure in FIG. 1B, according to the embodiment;

FIG. 2B is a perspective view schematically showing a state where a base member is set on the structure in FIG. 2A, according to the embodiment;

FIG. 3A and FIG. 3B each schematically show a cross section of a load sensor according to the embodiment;

FIG. 4 is a plan view schematically showing a configuration of the inside of the load sensor according to the embodiment;

FIG. 5 is a circuit diagram showing a configuration of a detection circuit according to the embodiment;

FIG. 6 is a block diagram showing a configuration of a load detecting device according to the embodiment;

FIG. 7 shows a state of a first detection circuit, a second detection circuit, a first switching circuit, and a second switching circuit in a preparation period, according to the embodiment;

FIG. 8 shows a state of the first detection circuit, the second detection circuit, the first switching circuit, and the second switching circuit in a detection period, according to the embodiment;

FIG. 9 shows a state of the first detection circuit, the second detection circuit, the first switching circuit, and the second switching circuit in a discharge period, according to the embodiment;

FIG. 10A is a time chart showing temporal changes in a first supply voltage and a first detection voltage in the first detection circuit, according to the embodiment;

FIG. 10B is a time chart showing temporal changes in a second supply voltage and a second detection voltage in the second detection circuit, according to the embodiment;

FIG. 11A is a time chart schematically showing a state where noise is superposed on the first detection voltage, according to the embodiment;

FIG. 11B is a time chart schematically showing a state where noise is superposed on the second detection voltage, according to the embodiment;

FIG. 12A to FIG. 12D are each a time chart showing an example of a process of generating a differential voltage on the basis of the first detection voltage and the second detection voltage, according to the embodiment;

FIG. 13A to FIG. 13C are each a time chart showing a method for detecting abnormality in an element part by using the second detection voltage, according to Modification 1;

FIG. 14 is a flowchart showing a process for detecting abnormality in an element part, according to Modification 1; and

FIG. 15 is a flowchart showing a load detection process according to Modification 2.

It is noted that the drawings are solely for description and do not limit the scope of the present invention in any way.

### DETAILED DESCRIPTION

A load detecting device according to the present invention is applicable to a management system or the like that performs processing in accordance with an applied load. In such a management system, for example, a plurality of load sensors can be used in order to detect a load in a wider range.

Examples of the management system include a stock management system, a driver monitoring system, a coaching management system, a security management system, and a caregiving/nursing management system.

In the stock management system, for example, by a load sensor provided to a stock shelf, the load of a placed stock is detected, and the kinds of commodities and the number of commodities present on the stock shelf are detected. Accordingly, in a store, a factory, a warehouse, and the like, the stock can be efficiently managed, and manpower saving can be realized. In addition, by a load sensor provided in a refrigerator, the load of food in the refrigerator is detected, and the kinds of the food and the quantity and amount of the food in the refrigerator are detected. Accordingly, a menu that uses food in a refrigerator can be automatically proposed.

In the driver monitoring system, by a load sensor provided to a steering device, the distribution of a load (e.g., gripping force, grip position, tread force) applied to the steering device by a driver is monitored, for example. In addition, by a load sensor provided to a vehicle-mounted seat, the distribution of a load (e.g., the position of the center of gravity) applied to the vehicle-mounted seat by the driver in a seated state is monitored. Accordingly, the driving state (sleepiness, mental state, and the like) of the driver can be fed back.

In the coaching management system, for example, by a load sensor provided to the bottom of a shoe, the load distribution at a sole is monitored. Accordingly, correction or guidance to an appropriate walking state or running state can be realized.

In the security management system, for example, by a load sensor provided to a floor, the load distribution is detected when a person passes, and the body weight, stride, passing speed, shoe sole pattern, and the like are detected. Accordingly, the person who has passed can be identified by checking these pieces of detection information against data.

In the caregiving/nursing management system, for example, by load sensors provided to bedclothes and a toilet seat, the distributions of loads applied by a human body to the bedclothes and the toilet seat are monitored. Accordingly, at the positions of the bedclothes and the toilet seat, what action the person is going to take is estimated, whereby tumbling or falling can be prevented.

The load detecting device of the embodiment below is applied to a management system as above, for example. The load detecting device of the embodiment below includes: a load sensor for detecting a load; and a detection circuit in combination with the load sensor. The load sensor of the embodiment below is a capacitance-type load sensor. Such a load sensor may be referred to as a “capacitance-type pressure-sensitive sensor element”, a “capacitive pressure detection sensor element”, a “pressure-sensitive switch element”, or the like. The embodiment below is an example of embodiments of the present invention, and the present invention is not limited to the embodiment below in any way.

Hereinafter, an embodiment of the present invention will be described with reference to the drawings. For convenience, X-, Y-, and Z-axes orthogonal to each other are indicated in the drawings. The Z-axis direction is the height direction of a load sensor 1.

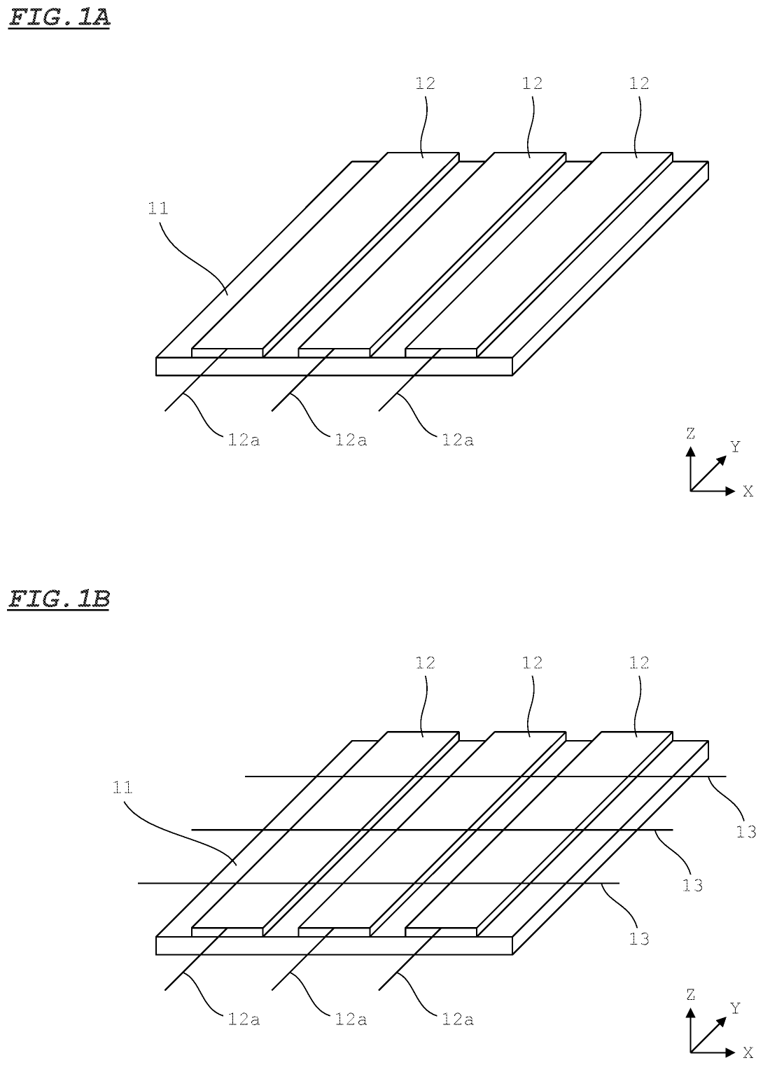

The load sensor 1 will be described with reference to FIG. 1A to FIG. 4.

FIG. 1A is a perspective view schematically showing a base member 11 and electrically-conductive elastic bodies 12 set on the upper face (the face on the Z-axis positive side) of the base member 11.

The base member 11 is an insulative flat plate-shaped member having elasticity. The base member 11 has a rectangular shape in a plan view. The thickness of the base member 11 is constant. The thickness of the base member 11 is 0.01 mm to 2 mm, for example. When the thickness of the base member 11 is small, the base member 11 may be referred to as a sheet member or a film member. The base member 11 is formed from a non-electrically-conductive resin material or a non-electrically-conductive rubber material.

The resin material used in the base member 11 is a resin material of at least one type selected from the group consisting of a styrene-based resin, a silicone-based resin (e.g., polydimethylpolysiloxane (PDMS)), an acrylic resin, a rotaxane-based resin, a urethane-based resin, and the like, for example. The rubber material used in the base member 11 is a rubber material of at least one type selected from the group consisting of silicone rubber, isoprene rubber, butadiene rubber, styrene-butadiene rubber, chloroprene rubber, nitrile rubber, polyisobutylene, ethylene-propylene rubber, chlorosulfonated polyethylene, acrylic rubber, fluororubber, epichlorohydrin rubber, urethane rubber, natural rubber, and the like, for example.

The electrically-conductive elastic bodies 12 are disposed on the upper face (the face on the Z-axis positive side) of the base member 11. In FIG. 1A, three electrically-conductive elastic bodies 12 are disposed on the upper face of the base member 11. Each electrically-conductive elastic body 12 is a member that is electrically conductive and that has elasticity. Each electrically-conductive elastic body 12 has a band-like shape that is long in the Y-axis direction. The three electrically-conductive elastic bodies 12 are disposed so as to be arranged with a predetermined interval therebetween in the X-axis direction. At an end portion on the Y-axis negative side of each electrically-conductive elastic body 12, a cable 12a electrically connected to the electrically-conductive elastic body 12 is set.

Each electrically-conductive elastic body 12 is formed on the upper face of the base member 11 by a printing method such as screen printing, gravure printing, flexographic printing, offset printing, or gravure offset printing. With these printing methods, the electrically-conductive elastic body 12 can be formed so as to have a thickness of about 0.001 mm to 0.5 mm on the upper face of the base member 11.

Each electrically-conductive elastic body 12 is formed from a resin material and an electrically-conductive filler dispersed therein, or from a rubber material and an electrically-conductive filler dispersed therein.

Similar to the resin material used in the base member 11 described above, the resin material used in the electrically-conductive elastic body 12 is a resin material of at least one type selected from the group consisting of a styrene-based resin, a silicone-based resin (e.g., polydimethylpolysiloxane (PDMS)), an acrylic resin, a rotaxane-based resin, a urethane-based resin, and the like, for example.

Similar to the rubber material used in the base member 11 described above, the rubber material used in the electrically-conductive elastic body 12 is a rubber material of at least one type selected from the group consisting of silicone rubber, isoprene rubber, butadiene rubber, styrene-butadiene rubber, chloroprene rubber, nitrile rubber, polyisobutylene, ethylene-propylene rubber, chlorosulfonated polyethylene, acrylic rubber, fluororubber, epichlorohydrin rubber, urethane rubber, natural rubber, and the like, for example.

The electrically-conductive filler used in the electrically-conductive elastic body 12 is a material of at least one type selected from the group consisting of: metal materials such as Au (gold), Ag (silver), Cu (copper), C (carbon), ZnO (zinc oxide), In₂O₃ (indium oxide (III)), and SnO₂ (tin oxide (IV)); electrically-conductive macromolecule materials such as PEDOT: PSS (i.e., a complex composed of poly(3,4-ethylenedioxythiophene) (PEDOT) and polystyrene sulfonate (PSS)); and electrically-conductive fibers such as a metal-coated organic matter fiber and a metal wire (fiber state), for example.

FIG. 1B is a perspective view schematically showing a state where conductor wires 13 are set on the structure in FIG. 1A.

Each conductor wire 13 has a linear shape and is disposed so as to be superposed on the upper faces of the electrically-conductive elastic bodies 12 shown in FIG. 1A. In the present embodiment, three conductor wires 13 are disposed so as to be superposed on the upper faces of the three electrically-conductive elastic bodies 12. The three conductor wires 13 are disposed so as to be arranged with a predetermined interval therebetween along the longitudinal direction (the Y-axis direction) of the electrically-conductive elastic bodies 12 so as to cross the electrically-conductive elastic bodies 12. Each conductor wire 13 is disposed, extending in the X-axis direction, so as to extend across the three electrically-conductive elastic bodies 12.

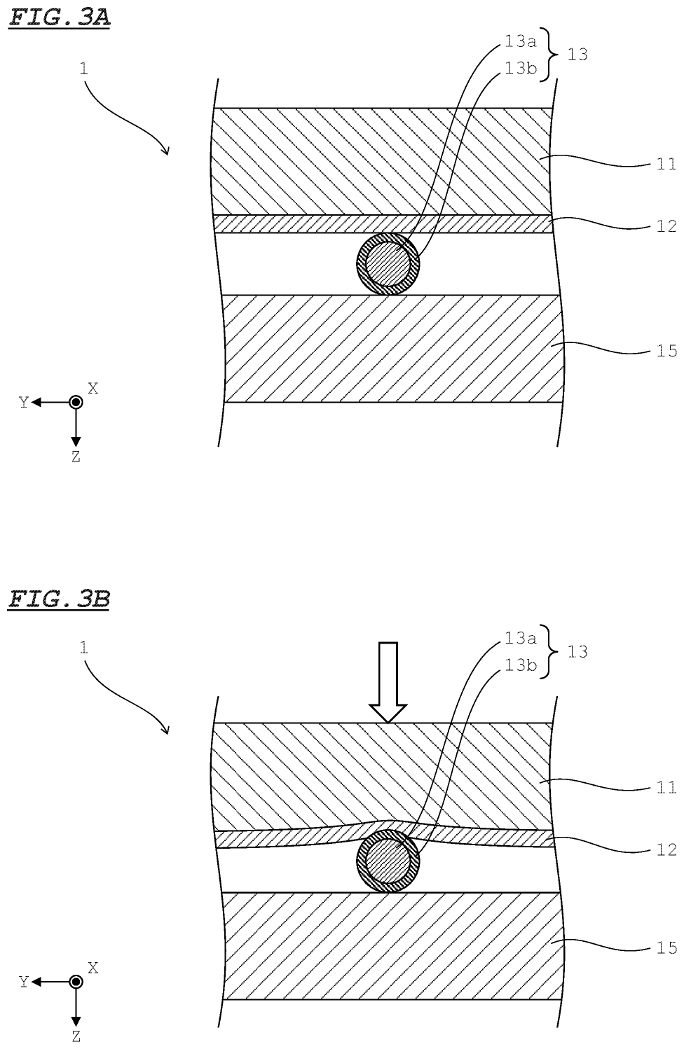

The conductor wire 13 is a covered copper wire, for example. The conductor wire 13 is composed of an electrically-conductive member having a linear shape and a dielectric body formed on the surface of the electrically-conductive member. The configuration of the conductor wire 13 will be described later with reference to FIGS. 3A, 3B.

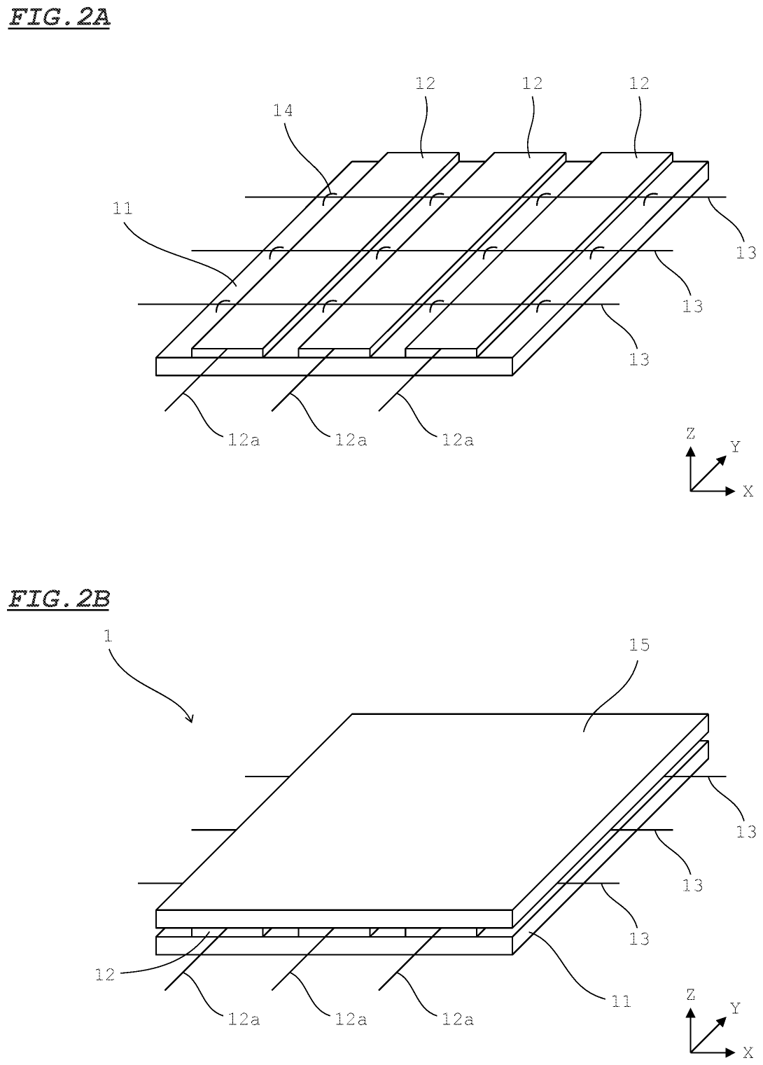

FIG. 2A is a perspective view schematically showing a state where threads 14 are set on the structure in FIG. 1B.

After the conductor wires 13 are disposed as shown in FIG. 1B, each conductor wire 13 is connected to the base member 11 by threads 14 so as to be able to move in the longitudinal direction (the X-axis direction) of the conductor wire 13. In the example shown in FIG. 2A, twelve threads 14 connect the conductor wires 13 to the base member 11 at positions other than the positions where the electrically-conductive elastic bodies 12 and the conductor wires 13 overlap each other. Each thread 14 is implemented by a chemical fiber, a natural fiber, a mixed fiber of the chemical fiber and the natural fiber, or the like.

FIG. 2B is a perspective view schematically showing a state where a base member 15 is set on the structure in FIG. 2A.

The base member 15 is set from above (the Z-axis positive side) the structure shown in FIG. 2A. The base member 15 is an insulative member. The base member 15 is a resin material of at least one type selected from the group consisting of polyethylene terephthalate, polycarbonate, polyimide, and the like, for example. The base member 15 may be formed from the same material as that of the base member 11. The base member 15 has a flat plate shape parallel to an X-Y plane, and has the same size and shape as those of the base member 11 in a plan view. The thickness in the Z-axis direction of the base member 15 is 0.01 mm to 2 mm, for example.

The outer peripheral four sides of the base member 15 are connected to the outer peripheral four sides of the base member 11 with a silicone rubber-based adhesive, a thread, or the like. Accordingly, the base member 15 is fixed to the base member 11. The conductor wires 13 are sandwiched by the electrically-conductive elastic bodies 12 and the base member 15. Accordingly, the load sensor 1 is completed as shown in FIG. 2B. The load sensor 1 can be used upside down from the state in FIG. 2B.

FIG. 3A and FIG. 3B each schematically show a cross section of the load sensor 1 along a plane parallel to a Y-Z plane at the center position in the X-axis direction of the electrically-conductive elastic body 12. FIG. 3A shows a state where no load is applied, and FIG. 3B shows a state where a load is applied.

As shown in FIGS. 3A, 3B, the conductor wire 13 is composed of an electrically-conductive member 13a and a dielectric body 13b formed on the electrically-conductive member 13a. The electrically-conductive member 13a is a member that is electrically conductive and that has a linear shape. The dielectric body 13b covers the surface of the electrically-conductive member 13a. The electrically-conductive member 13a is formed from copper, for example. The diameter of the electrically-conductive member 13a is about 60 μm, for example.

The dielectric body 13b has an electric insulation property, and is formed from a resin material, a ceramic material, a metal oxide material, or the like, for example. The dielectric body 13b may be a resin material of at least one type selected from the group consisting of a polypropylene resin, a polyester resin (e.g., polyethylene terephthalate resin), a polyimide resin, a polyphenylene sulfide resin, a polyvinyl formal resin, a polyurethane resin, a polyamide imide resin, a polyamide resin, and the like. Alternatively, the dielectric body 13b may be a metal oxide material of at least one type selected from the group consisting of Al₂O₃, Ta₂O₅, and the like.

As shown in FIG. 3A, when no load is applied, the force applied between the electrically-conductive elastic body 12 and the conductor wire 13, and the force applied between the base member 15 and the conductor wire 13 is substantially zero. From this state, when a load is applied to the face on the Z-axis negative side of the base member 11 as shown in FIG. 3B, the electrically-conductive elastic body 12 and the base member 11 are deformed by the conductor wire 13.

As shown in FIG. 3B, due to the application of a load, the conductor wire 13 is brought close to the electrically-conductive elastic body 12 so as to be wrapped by the electrically-conductive elastic body 12. In association with this, the contact area between the conductor wire 13 and the electrically-conductive elastic body 12 increases. Accordingly, the capacitance between the electrically-conductive member 13a and the electrically-conductive elastic body 12 changes. The capacitance between the electrically-conductive member 13a and the electrically-conductive elastic body 12 is detected, whereby the load applied to this region is acquired.

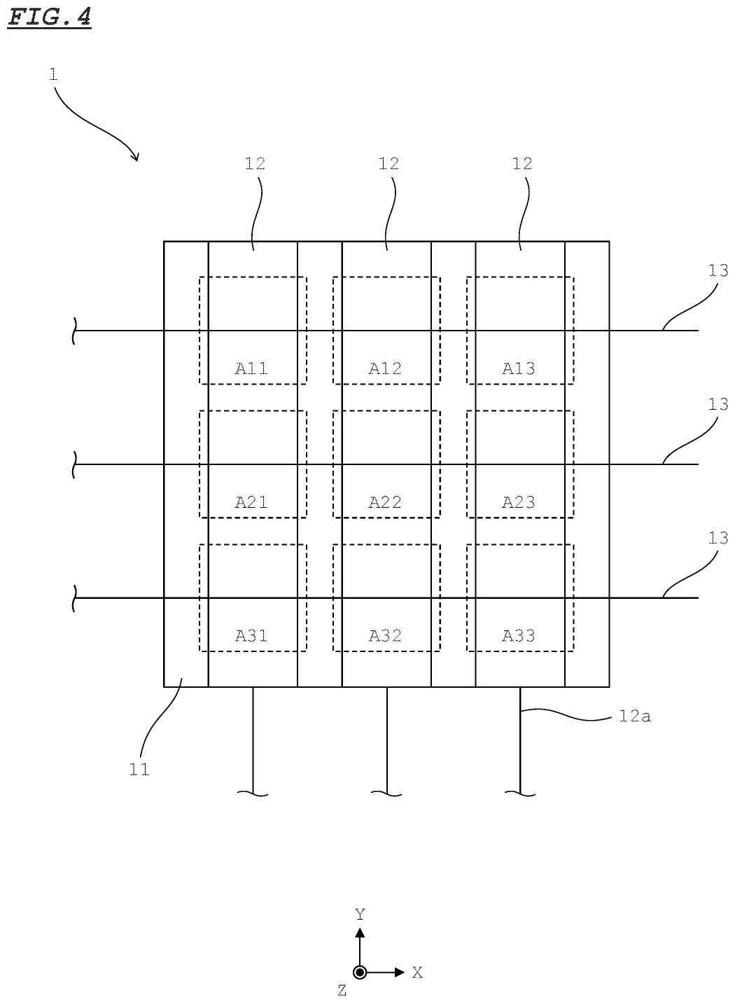

FIG. 4 is a plan view schematically showing a configuration of the inside of the load sensor 1. In FIG. 4, the threads 14 and the base member 15 are not shown for convenience.

As shown in FIG. 4, element parts A11, A12, A13, A21, A22, A23, A31, A32, A33 in which the capacitance changes in accordance with a load are formed at positions where the three electrically-conductive elastic bodies 12 and the three conductor wires 13 cross each other. Each element part includes an electrically-conductive elastic body 12 and a conductor wire 13 in the vicinity of the intersection between the electrically-conductive elastic body 12 and the conductor wire 13.

In each element part, the conductor wire 13 forms one pole (e.g., positive pole) for capacitance and the electrically-conductive elastic body 12 forms the other pole (e.g., negative pole) for capacitance. That is, the electrically-conductive member 13a (see FIGS. 3A, 3B) in the conductor wire 13 forms one electrode of the load sensor 1 (capacitance-type load sensor), the electrically-conductive elastic body 12 forms the other electrode of the load sensor 1 (capacitance-type load sensor), and the dielectric body 13b (see FIGS. 3A, 3B) included in the conductor wire 13 corresponds to a dielectric body that defines the capacitance in the load sensor 1 (capacitance-type load sensor).

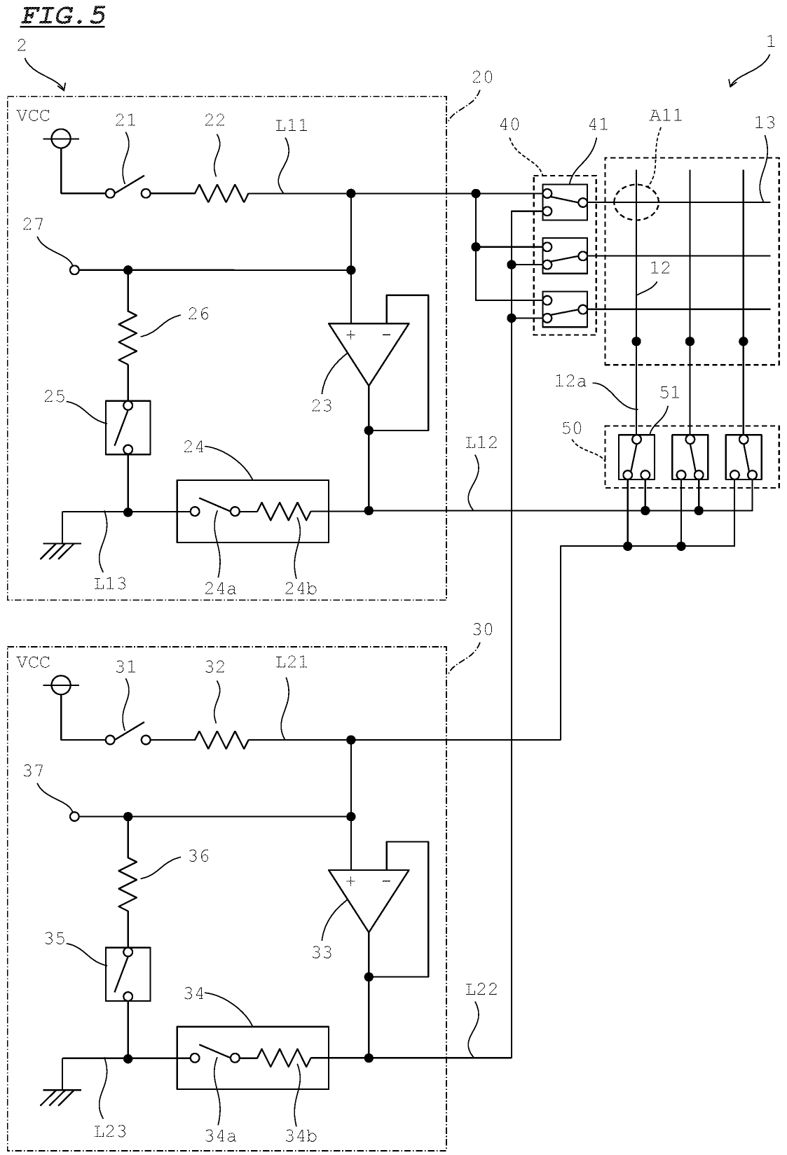

When a load is applied in the Z-axis direction to each element part, the conductor wire 13 is wrapped by the electrically-conductive elastic body 12. Accordingly, the contact area between the conductor wire 13 and the electrically-conductive elastic body 12 changes, and the capacitance between the conductor wire 13 and the electrically-conductive elastic body 12 changes. An end portion on the X-axis negative side of each conductor wire 13 and an end portion on the Y-axis negative side of the cable 12a set to each electrically-conductive elastic body 12 are connected to a detection circuit 2 described later with reference to FIG. 5.

When a load is applied to the element part A11, the contact area between the electrically-conductive member 13a of the conductor wire 13 and the electrically-conductive elastic body 12 increases via the dielectric body 13b in the element part A11. In this case, when the capacitance between the electrically-conductive elastic body 12 on the most X-axis negative side and the conductor wire 13 on the most Y-axis positive side is detected, the load applied to the element part A11 can be calculated. Similarly, in another element part as well, when the capacitance between the electrically-conductive elastic body 12 and the conductor wire 13 crossing each other in the other element part is detected, the load applied to the other element part can be calculated.

FIG. 5 is a circuit diagram showing a configuration of the detection circuit 2 which detects the capacitance in each element part. In FIG. 5, for convenience, as the configuration of the load sensor 1, only the conductor wires 13 and the electrically-conductive elastic bodies 12 are shown, and the electrically-conductive elastic bodies 12 are each shown in a linear shape.

The detection circuit 2 includes a first detection circuit 20, a second detection circuit 30, a first switching circuit 40, and a second switching circuit 50. The detection circuit 2 is a circuit for detecting change in the capacitance at each crossing position between a conductor wire 13 and an electrically-conductive elastic body 12 with respect to the load sensor 1.

The first detection circuit 20 includes a switch 21, a resistor 22, an equipotential generation part 23, switches 24, 25, a resistor 26, and a voltage measurement terminal 27.

One terminal of the switch 21 is connected to a VCC power supply line of a load detecting device 4 described later, and the other terminal of the switch 21 is connected to the resistor 22. The resistor 22 is disposed between the switch 21 and the plurality of the conductor wires 13. A supply line L11 is connected to the downstream-side terminal of the resistor 22.

The supply line L11 is connected to the first switching circuit 40, the equipotential generation part 23, the resistor 26, and the voltage measurement terminal 27. The output-side terminal of the equipotential generation part 23 is connected to a supply line L12. The equipotential generation part 23 is an operational amplifier, and the output-side terminal and the input-side negative terminal are connected to each other. The equipotential generation part 23 generates a suppression voltage that is equipotential to the potential (the potential on the downstream side of the resistor 22) of the supply line L11.

The supply line L12 is connected to the equipotential generation part 23 and the second switching circuit 50. The switch 24 is an electric element including a resistor component interposed between the supply line L12 and a ground line L13. In FIG. 5, for convenience, the switching function of the switch 24 is shown as a switch part 24a, and the resistor component of the switch 24 is shown as a resistor part 24b. When the switch part 24a is set to an ON-state, the supply line L12 is connected to the ground line L13 via the resistor part 24b.

The switch 25 is interposed between the supply line L11 and the ground line L13. When the switch 25 is set to an ON-state, the supply line L11 is connected to the ground line L13 via the resistor 26. The voltage measurement terminal 27 is connected to a control circuit 3 described later.

The second detection circuit 30 has a configuration similar to that of the first detection circuit 20. The second detection circuit 30 includes a switch 31, a resistor 32, an equipotential generation part 33, switches 34, 35, a resistor 36, and a voltage measurement terminal 37.

A supply line L21 is connected to the second switching circuit 50, the equipotential generation part 33, the resistor 36, and the voltage measurement terminal 37. The output-side terminal of the equipotential generation part 33 is connected to a supply line L22. The equipotential generation part 33 is an operational amplifier, and generates a suppression voltage that is equipotential to the potential (the potential on the downstream side of the resistor 32) of the supply line L21.

The supply line L22 is connected to the equipotential generation part 33 and the first switching circuit 40. The switch 34 is an electric element including a resistor component interposed between the supply line L22 and a ground line L23. For convenience, the switching function of the switch 34 is shown as a switch part 34a, and the resistor component of the switch 34 is shown as a resistor part 34b. When the switch part 34a is set to an ON-state, the supply line L22 is connected to the ground line L23 via the resistor part 34b.

The switch 35 is interposed between the supply line L21 and the ground line L23. When the switch 35 is set to an ON-state, the supply line L21 is connected to the ground line L23 via the resistor 36. The voltage measurement terminal 37 is connected to the control circuit 3 described later.

The first switching circuit 40 selectively connects either one of the supply line L11 for supplying the potential on the downstream side of the resistor 22 and the supply line L22 for supplying the suppression voltage, to each of the plurality of the conductor wires 13 (the electrically-conductive members 13a).

Specifically, the first switching circuit 40 includes three multiplexers 41. The three multiplexers 41 are provided so as to correspond to the three conductor wires 13 (the electrically-conductive members 13a), respectively. To the output-side terminal of each multiplexer 41, the electrically-conductive member 13a of the conductor wire 13 is connected. Each multiplexer 41 is provided with two input-side terminals. The supply line L11 is connected to one input-side terminal, and to this input-side terminal, a voltage is applied from the VCC power supply line via the resistor 22 and the supply line L11. The other input-side terminal of the multiplexer 41 is connected to the supply line L22, and to this input-side terminal, the suppression voltage is applied from the equipotential generation part 33 via the supply line L22.

The second switching circuit 50 selectively connects either one of the supply line L12 for supplying the suppression voltage and the supply line L21 for supplying the potential on the downstream side of the resistor 32, to each electrically-conductive elastic body 12 (the cable 12a).

Specifically, the second switching circuit 50 includes three multiplexers 51. The three multiplexers 51 are provided so as to correspond to the three electrically-conductive elastic bodies 12 (the cables 12a), respectively. To the output-side terminal of each multiplexer 51, the cable 12a connected to the electrically-conductive elastic body 12 is connected. Each multiplexer 51 is provided with two input-side terminals. The supply line L12 is connected to one input-side terminal, and to this input-side terminal, the suppression voltage is applied from the equipotential generation part 23 via the supply line L12. To the other input-side terminal of the multiplexer 51, the potential on the downstream side of the resistor 32 is supplied via the supply line L21.

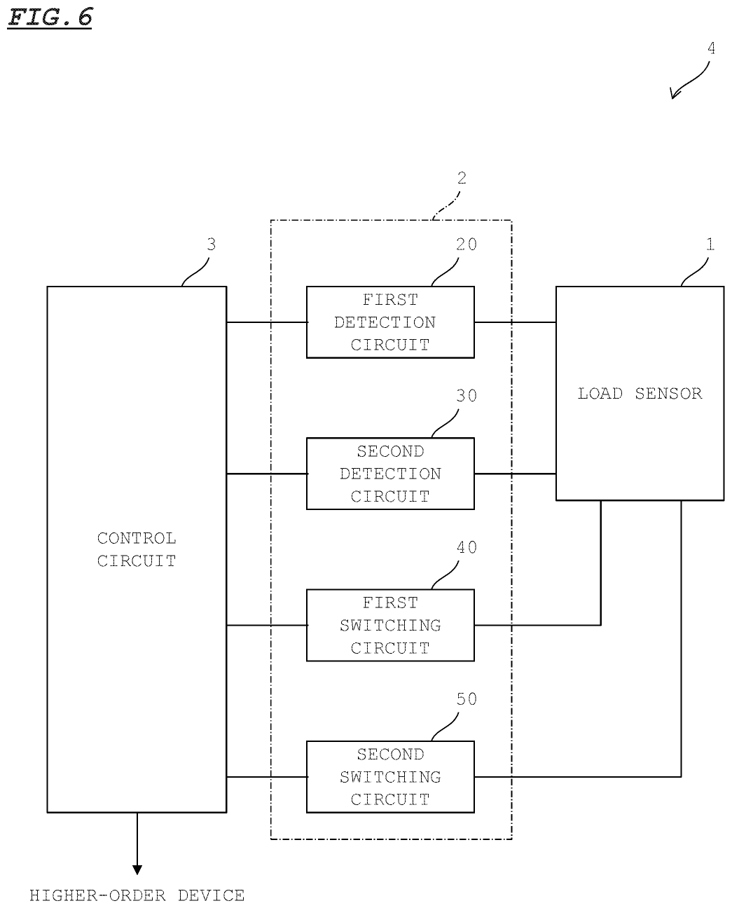

Switching of the switches 21, 31, the switch parts 24a, 34a, the switches 25, 35, and the multiplexers 41, 51 is controlled by the control circuit 3 (see FIG. 6) as described later.

FIG. 6 is a block diagram showing a configuration of the load detecting device 4.

The load detecting device 4 includes the control circuit 3 in addition to the load sensor 1 and the detection circuit 2.

The control circuit 3 includes arithmetic processing circuits such as a microcomputer and a CPU (Central Processing Unit), and a memory holding programs executed by these arithmetic processing circuits. The memory is also used as a work region during execution of the programs. The control circuit 3 may include a plurality of arithmetic processing circuits or may include an FPGA (Field Programmable Gate Array).

The control circuit 3 controls the switches 21, 24, 25, 31, 34, 35 of the first detection circuit 20 and the second detection circuit 30 and the multiplexers 41, 51 of the first switching circuit 40 and the second switching circuit 50 shown in FIG. 5. In addition, the control circuit 3 sequentially acquires a potential signal of each element part acquired via the voltage measurement terminals 27, 37 of the first detection circuit 20 and the second detection circuit 30, and performs AD conversion on the acquired potential signals to generate potential data.

Further, based on the potential data of each element part, the control circuit 3 calculates the capacitance in each element part of the load sensor 1. Then, based on the capacitance in each element part, the control circuit 3 acquires the load applied to the element part. Then, the control circuit 3 transmits the acquired load in each element part to a higher-order device such as a management device as needed.

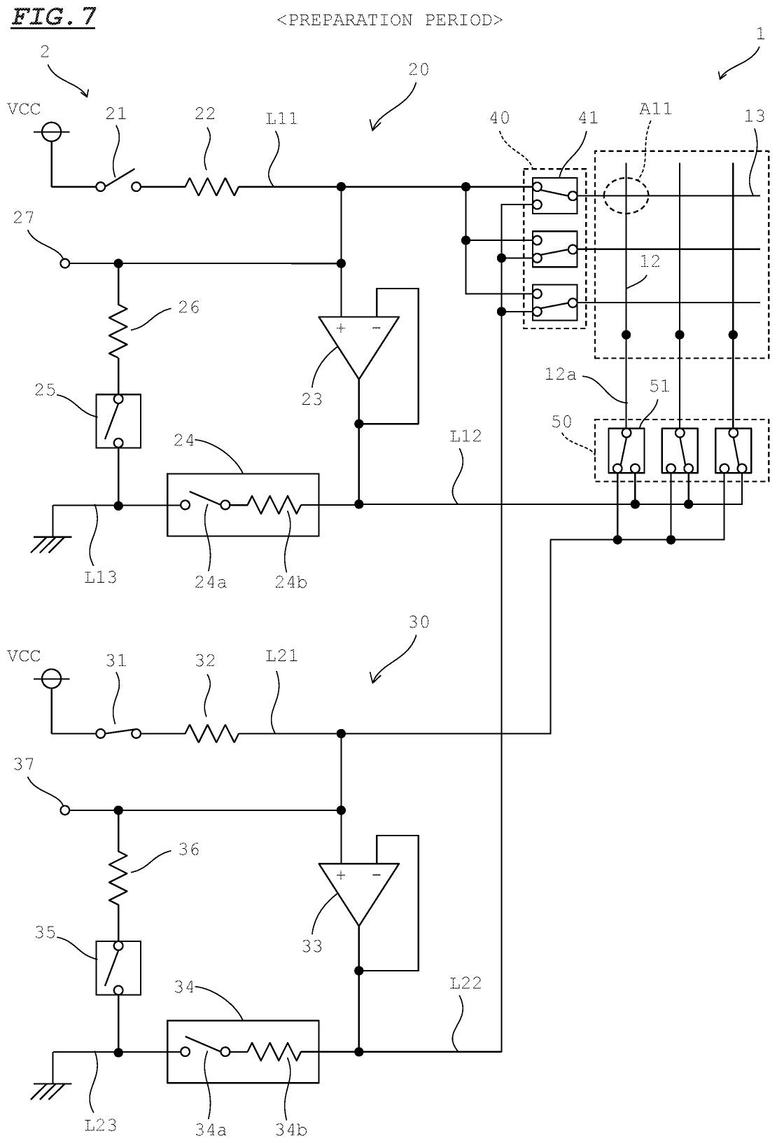

FIG. 7 to FIG. 9 each show a state of the first detection circuit 20, the second detection circuit 30, the first switching circuit 40, and the second switching circuit 50 during load detection.

In FIG. 7 to FIG. 9, the element part A11 shown in FIG. 7 is the detection target. In detection of the capacitance with respect to one element part, the control circuit 3 executes control in each period of a preparation period, a detection period, and a discharge period. The preparation period, the detection period, and the discharge period are consecutive in this order. When one cycle of the preparation period, the detection period, and the discharge period has ended, the next cycle is executed repeatedly.

FIG. 7 shows a state of the first detection circuit 20, the second detection circuit 30, the first switching circuit 40, and the second switching circuit 50 in the preparation period.

In the preparation period, the switches 21, 24, 25 of the first detection circuit 20 are open. In addition, the switch 31 of the second detection circuit 30 is closed, and the switches 34, 35 are open. Here, since the element part A11 is the detection target, in the first switching circuit 40, only the uppermost multiplexer 41 is connected to the supply line L11, and the other multiplexers 41 are connected to the supply line L22. In the second switching circuit 50, only the leftmost multiplexer 51 is connected to the supply line L21, and the other multiplexers 51 are connected to the supply line L12.

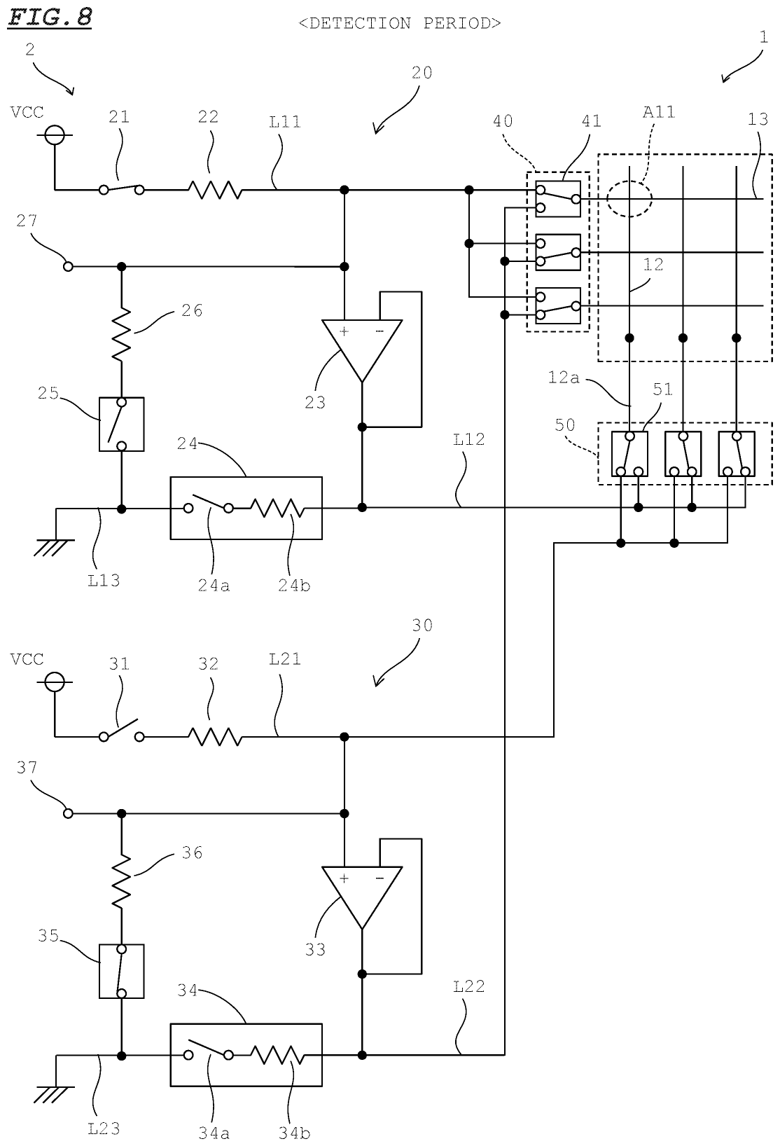

FIG. 8 shows a state of the first detection circuit 20, the second detection circuit 30, the first switching circuit 40, and the second switching circuit 50 in the detection period.

At the timing when the preparation period is shifted to the detection period, the switch 21 of the first detection circuit 20 is closed. In addition, the switch 31 of the second detection circuit 30 is opened, and the switch 35 is closed. In the first switching circuit 40 and the second switching circuit 50, the states in the preparation period are maintained.

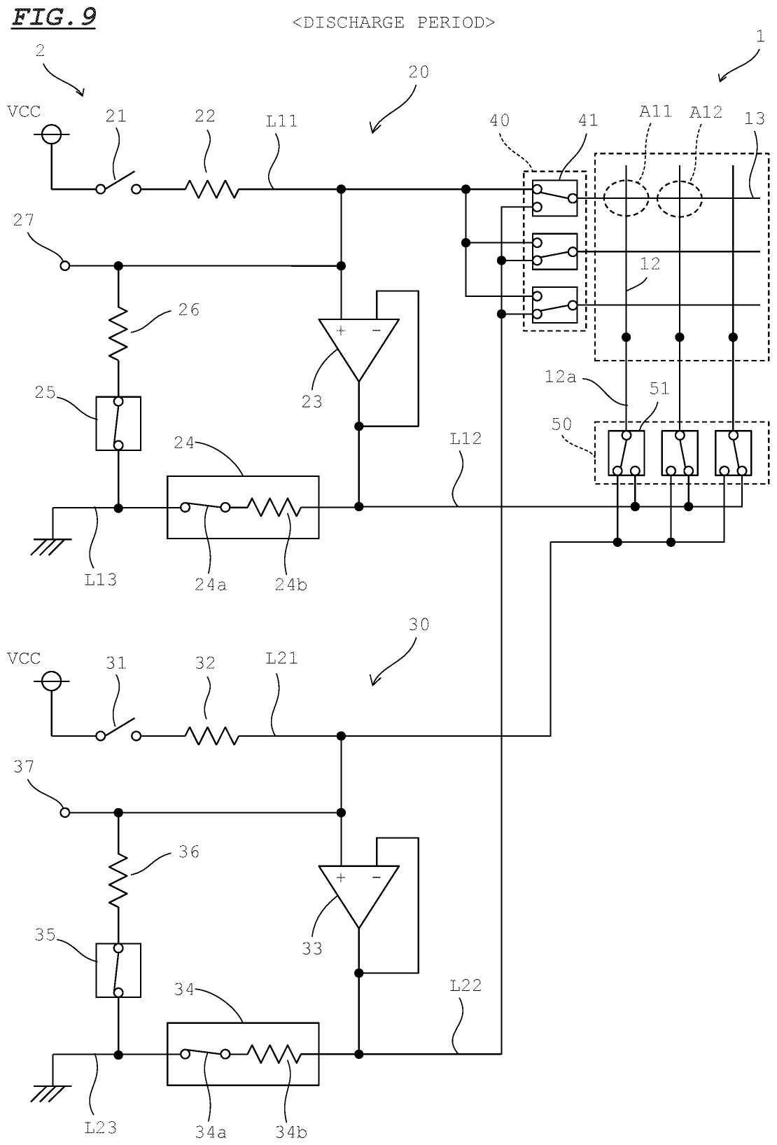

FIG. 9 shows a state of the first detection circuit 20, the second detection circuit 30, the first switching circuit 40, and the second switching circuit 50 in the discharge period.

At the timing when the detection period is shifted to the discharge period, the switch 21 of the first detection circuit 20 is opened, and the switches 24, 25 are closed. In the switches 31, 35 of the second detection circuit 30, the states in the detection period in FIG. 8 are maintained, and the switch 34 is closed. In the first switching circuit 40 and the second switching circuit 50, the states in the preparation period and the detection period are maintained.

When the discharge period has ended, the discharge period is shifted to the next preparation period, with the element part A12 set as the detection target. At this time, the switches 21, 24, 25 of the first detection circuit 20 and the switches 31, 34, 35 of the second detection circuit 30 are set to be in the states in FIG. 7. Further, in association with the detection target being shifted to the element part A12, in the second switching circuit 50, the center multiplexer 51 is connected to the supply line L21, and the other multiplexers 51 are connected to the supply line L12.

In the detection period and the discharge period thereafter, control similar to the above is performed. Then, in the preparation period of the next cycle subsequent to this discharge period, in the second switching circuit 50, the rightmost multiplexer 51 is connected to the supply line L21, and the other multiplexers 51 are connected to the supply line L12. Then, with respect to the element part (the element part A13) at the crossing position between the uppermost conductor wire 13 and the rightmost electrically-conductive elastic body 12, control similar to the above is executed.

Then, upon completion of the control with respect to the element parts (the element parts A11 to A13) at the crossing positions between the uppermost conductor wire 13 and the three electrically-conductive elastic bodies 12, the control is shifted to control with respect to the element parts (the element parts A21 to A23) at the crossing positions between the center conductor wire 13 and the three electrically-conductive elastic bodies 12.

In this case, from the states in FIG. 7 to FIG. 9, only the state of the first switching circuit 40 is changed. That is, in the first switching circuit 40, the center multiplexer 41 is connected to the supply line L11, and the other multiplexers 41 are connected to the supply line L22. This switching is executed in the preparation period for the crossing position (the element part A21) between the center conductor wire 13 and the leftmost electrically-conductive elastic body 12. In this state, similar to the above, control with respect to the element parts (the element parts A21 to A23) at the crossing positions between the center conductor wire 13 and the three electrically-conductive elastic bodies 12 is performed.

Then, similar control is executed with respect to the element parts (the element parts A31 to A33) at the crossing positions between the lowermost conductor wire 13 and the three electrically-conductive elastic bodies 12. Upon completion of this control, the state returns to the state in FIG. 7, and control with respect to the element parts (the element parts A11 to A13) at the crossing positions between the uppermost conductor wire 13 and the three electrically-conductive elastic bodies 12 is performed. Control thereafter is similar to the above.

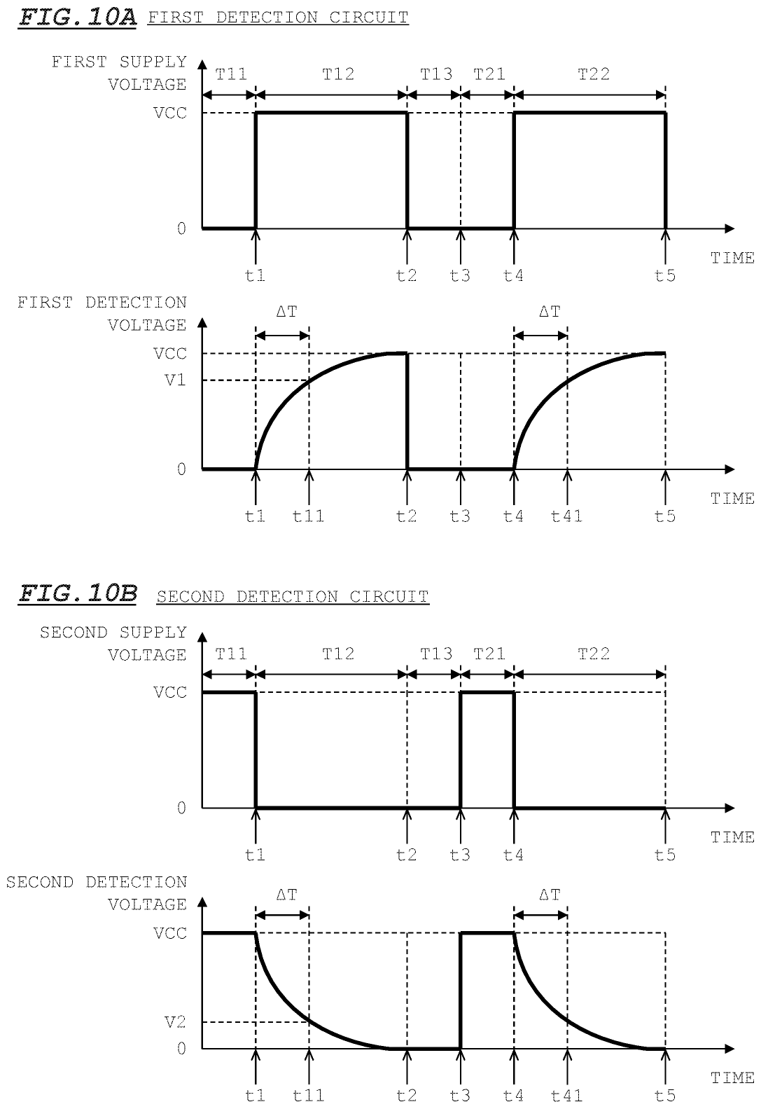

FIG. 10A is a time chart showing the voltage (first supply voltage) immediately after the switch 21 of the first detection circuit 20 and the voltage (first detection voltage) that appears at the voltage measurement terminal 27. In the upper part of FIG. 10A, temporal change in the first supply voltage is shown. In the lower part of FIG. 10A, temporal change in the first detection voltage is shown.

FIG. 10B is a time chart showing the voltage (second supply voltage) immediately after the switch 31 of the second detection circuit 30 and the voltage (second detection voltage) that appears at the voltage measurement terminal 37. In the upper part of FIG. 10B, temporal change in the second supply voltage is shown. In the lower part of FIG. 10B, temporal change in the second detection voltage is shown.

In FIGS. 10A, 10B, periods T11, T12, T13 are the preparation period, the detection period, and the discharge period described above, respectively. In FIGS. 10A, 10B, the discharge period T13 is followed by a preparation period T21 and a detection period T22 in the next cycle. The period up to time t1 is the preparation period T11, time t1 to time t2 is the detection period T12, and time t2 to time t3 is the discharge period T13. Time t3 to time t4 is the preparation period T21 of the next cycle, and time t4 to time t5 is the detection period T22 of the next cycle.

Here, the preparation period T11, the detection period T12, and the discharge period T13 are set when the element part serving as the detection target is the element part A11, and the preparation period T21 and the detection period T22 are set when the element part serving as the detection target is the element part A12.

In the preparation period T11, as shown in FIG. 7, the switch 21 of the first detection circuit 20 is open, and the switches 24, 25 are also open. Therefore, in the preparation period T11, as shown in FIG. 10A, the first supply voltage immediately after the switch 21 is at a zero level, and the first detection voltage at the voltage measurement terminal 27 is also at a zero level.

On the other hand, in the preparation period T11, as shown in FIG. 7, the switch 31 of the second detection circuit 30 is closed, and the switches 34, 35 are open. Therefore, in the preparation period T11, as shown in FIG. 10B, the second supply voltage immediately after the switch 31 is the voltage VCC, and the second detection voltage at the voltage measurement terminal 37 is also the voltage VCC.

In the detection period T12 subsequent to the preparation period T11, as shown in FIG. 8, the switch 21 of the first detection circuit 20 is closed, and the switches 24, 25 are open. Therefore, in the detection period T12, as shown in FIG. 10A, the first supply voltage immediately after the switch 21 is the voltage VCC.

Since the switch 21 is closed, charging with respect to the element part A11 serving as the detection target is performed via the conductor wire 13 in the element part A11. At this time, to the electrically-conductive elastic bodies 12 of the other two element parts A12, A13 in the same row as the element part A11, the same potential as that in the supply line L11 is applied from the equipotential generation part 23. Therefore, charging with respect to the other two element parts A12, A13 does not occur. Accordingly, as shown in FIG. 10A, the first detection voltage appearing at the voltage measurement terminal 27 in the detection period T12 gradually increases according to the time constant defined by the resistor 22 and the capacitance in the element part A11 serving as the detection target.

On the other hand, in the detection period T12, as shown in FIG. 8, the switch 31 of the second detection circuit 30 is open, and the switch 35 is closed. Therefore, in the detection period T12, as shown in FIG. 10B, the second supply voltage immediately after the switch 31 is zero. Since the switch 35 is closed, the electrically-conductive elastic body 12 in the element part A11 serving as the detection target is connected to the ground via the switch 35 and the resistor 36. Accordingly, discharging with respect to the element part A11 is performed via the electrically-conductive elastic body 12 in the element part A11. At this time, to the conductor wires 13 in the other two element parts (the element parts at the crossing positions between the leftmost electrically-conductive elastic body 12 and the center and lowermost conductor wires 13) in the same column as the element part A11, the same potential as that in the supply line L21 is applied from the equipotential generation part 33. Therefore, discharging with respect to the other two element parts A21, A31 does not occur. Accordingly, as shown in FIG. 10B, the second detection voltage appearing at the voltage measurement terminal 37 in the detection period T12 gradually decreases according to the time constant defined by the resistor 36 and the capacitance in the element part A11 serving as the detection target.

Here, the resistor 22 of the first detection circuit 20 and the resistor 36 of the second detection circuit 30 are set to have the same value. Therefore, the time constant during charging in the first detection circuit 20 and the time constant during discharging in the second detection circuit 30 are substantially the same. Therefore, as shown in FIGS. 10A, 10B, the period in which the first detection voltage increases from zero to VCC is substantially the same as the period in which the second detection voltage decreases from VCC to zero.

In the discharge period T13 subsequent to the detection period T12, as shown in FIG. 9, the switch 21 of the first detection circuit 20 is open, and the switches 24, 25 are closed.

Therefore, in the discharge period T13, as shown in FIG. 10A, the first supply voltage immediately after the switch 21 falls to a zero level. Since the switch 25 is closed, the conductor wire 13 in the element part A11 serving as the detection target is connected to the ground via the switch 25 and the resistor 26. Accordingly, discharging with respect to the element part A11 is performed via the conductor wire 13. At this time, also with respect to the other two element parts A12, A13 in the same row as the element part A11, discharging is performed via the uppermost conductor wire 13.

Here, the resistance value of the resistor 26 is set to be significantly smaller than the resistance value of the resistor 22. Therefore, the time constant during this discharging becomes small. Accordingly, as shown in FIG. 10A, instantaneously after the start of the discharge period T13, the first detection voltage falls to a zero level.

On the other hand, in the discharge period T13, as shown in FIG. 9, in the switches 31, 35 of the second detection circuit 30, the states in FIG. 8 are maintained, and the switch 34 is closed. Therefore, in the discharge period T13, as shown in FIG. 10B, the second supply voltage is maintained at a zero level, and the second detection voltage is also maintained at a zero level.

Then, the period is shifted to the preparation period T21 for the next element part A12. Accordingly, the switches 21, 24, 25 of the first detection circuit 20 are set to be in the states in FIG. 7. Therefore, as shown in FIG. 10A, the first supply voltage and the first detection voltage in the preparation period T21 are maintained at a zero level.

On the other hand, in association with the shift from the discharge period T13 to the preparation period T21, the switches 31, 34, 35 of the second detection circuit 30 are set to be in the states in FIG. 7. In addition, in the second switching circuit 50, the center multiplexer 51 is connected to the supply line L21, and the other multiplexers 51 are connected to the supply line L12. Therefore, in the preparation period T21, as shown in FIG. 10B, the second supply voltage immediately after the switch 31 rises to the voltage VCC. Since the switch 31 is closed, charging with respect to the element part A12 serving as the next detection target is performed via the electrically-conductive elastic body 12 in the element part A12. At this time, to the conductor wires 13 in the other two element parts (the element parts at the crossing positions between the center electrically-conductive elastic body 12 and the center and lowermost conductor wires 13) in the same column as the element part A12, the same potential as that in the supply line L21 is applied from the equipotential generation part 33. Therefore, charging with respect to these other element parts A22, A32 does not occur.

Here, the resistance value of the resistor 32 is set to be significantly smaller than the resistance value of the resistor 36. Therefore, the time constant during this charging becomes small. Accordingly, as shown in FIG. 10B, instantaneously after the start of the preparation period T21, the second detection voltage rises to the voltage VCC. Thereafter, with respect to the first detection circuit 20 and the second detection circuit 30, control similar to the above is performed from the control circuit 3.

Here, as described above, the capacitance in the element part A11 has a magnitude according to the load applied to the element part A11. On the other hand, in the detection period T12, the first detection voltage changes according to the time constant based on the resistor 22 and the capacitance in the element part A11, and the second detection voltage changes according to the time constant based on the resistor 36 and the capacitance in the element part A11. Therefore, for example, a voltage value V1 of the first detection voltage at time t11 after elapse of a certain time period ΔT from the start time t1 of the detection period T12 becomes a value according to the capacitance in the element part A11. Similarly, a voltage value V2 of the second detection voltage at time t11 becomes a value according to the capacitance in the element part A11.

Therefore, the value of the capacitance in the element part A11 can be calculated from the voltage value V1 of the first detection voltage at time t11 and the resistance value of the resistor 22 of the first detection circuit 20, for example. In addition, from the calculated value of the capacitance, the magnitude of the load applied to the element part A11 can be acquired. With respect to the element part A12 as well, similarly, the capacitance in the element part A12 can be calculated from the voltage value of the first detection voltage at time t41, and the load applied to the element part A12 can be acquired.

However, for example, when a metal or a dielectric body is present around the load sensor 1, noise may be superposed on the first detection voltage after the resistor 22. In this case, when the capacitance is detected through the above process on the basis of the first detection voltage, the capacitance in each element part may fail to be accurately detected due to the superposed noise.

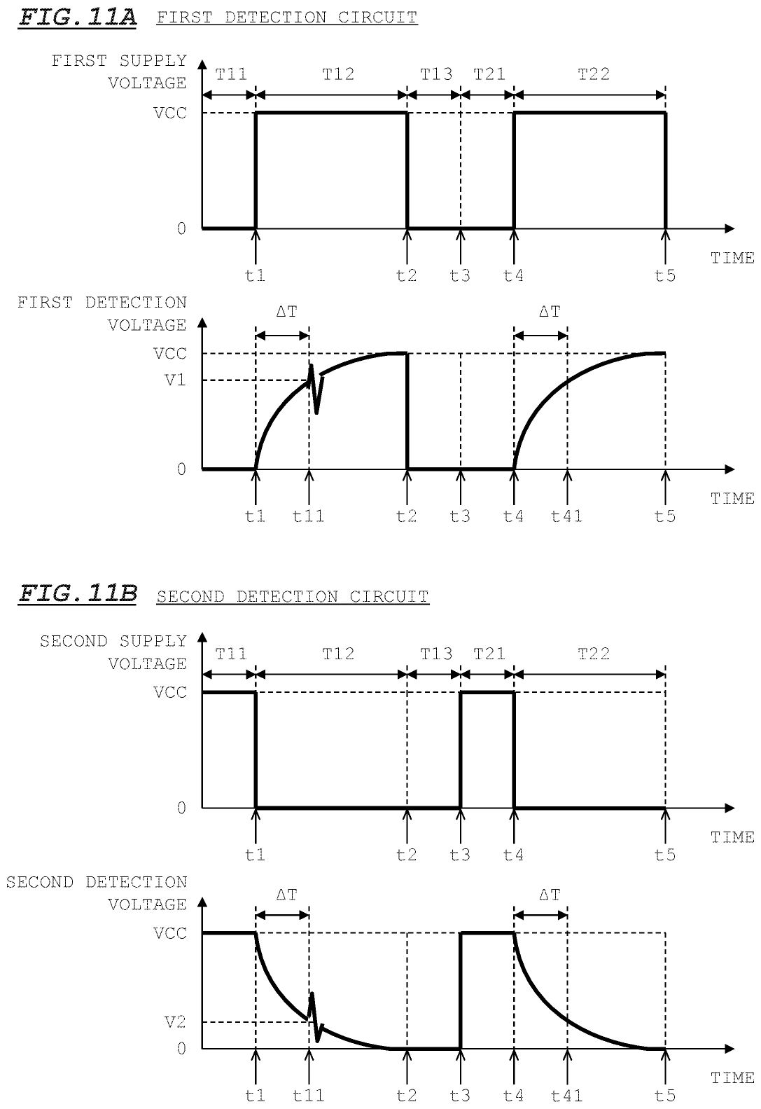

FIG. 11A is a time chart schematically showing a state where noise is superposed on the first detection voltage outputted from the voltage measurement terminal 27 of the first detection circuit 20. FIG. 11B is a time chart schematically showing a state where noise is superposed on the second detection voltage outputted from the voltage measurement terminal 37 of the second detection circuit 30.

As shown in FIG. 11A, when noise is superposed on the first detection voltage at time t11 being the detection timing of the capacitance, the voltage value of the first detection voltage at time t11 varies from the normal voltage value V1. Therefore, the capacitance in the element part A11 cannot be appropriately calculated based on the first detection voltage, and as a result, the detection accuracy for the load applied to the element part A11 decreases.

In order to solve such a problem, in the present embodiment, calculation of the capacitance with respect to each element part is performed by using the second detection voltage together with the first detection voltage. Specifically, the control circuit 3 detects the capacitance in each element part, based on a differential voltage obtained by adding a voltage obtained by inverting the second detection voltage outputted from the second detection circuit 30 between the voltage VCC and the ground, to the first detection voltage outputted from the first detection circuit 20.

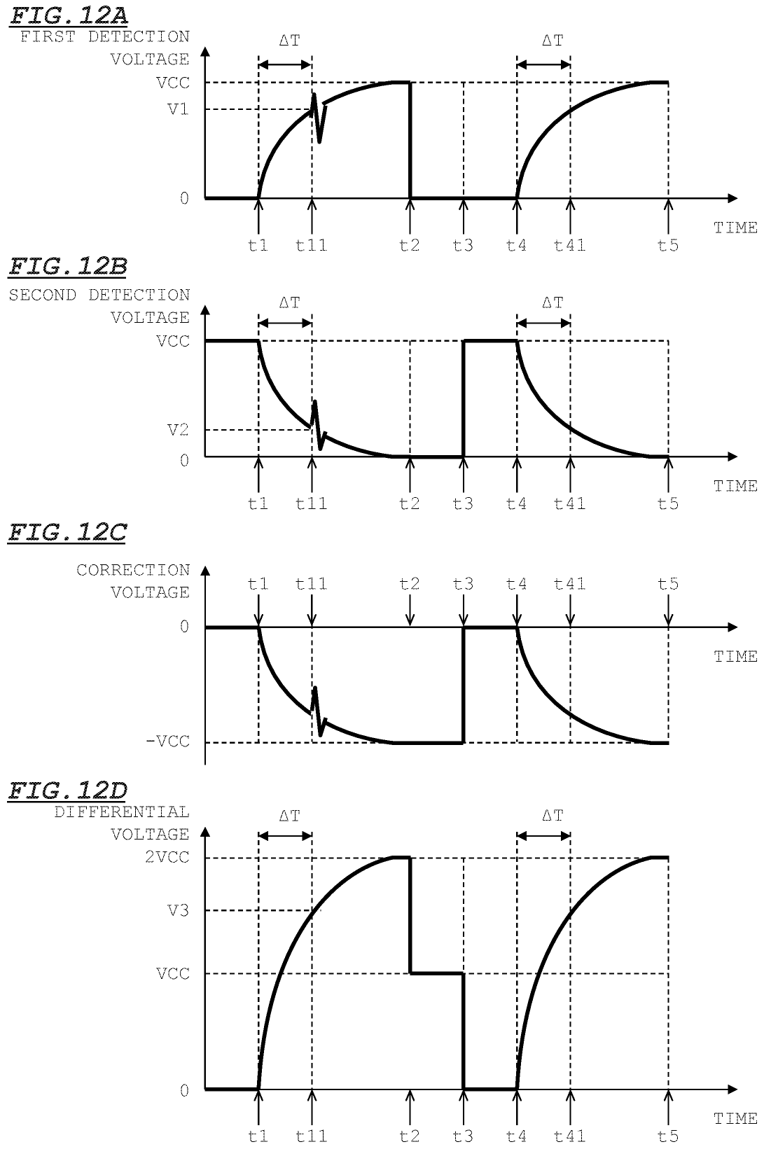

FIG. 12A to FIG. 12D are each a time chart showing an example of a process of generating a differential voltage on the basis of the first detection voltage and the second detection voltage.

As shown in FIGS. 12A, 12B, noise due to a metal or a dielectric body present around the load sensor 1 occurs at substantially the same timing and in substantially the same waveform in the first detection voltage and the second detection voltage.

The control circuit 3 generates a correction voltage by decreasing, by the voltage VCC, the second detection voltage inputted from the voltage measurement terminal 37 of the second detection circuit 30. As shown in FIG. 12C, the correction voltage has a waveform in which the same waveform as that of the second detection voltage changes in the negative range. The control circuit 3 performs a process of subtracting the correction voltage from the first detection voltage to calculate the differential voltage. Through this subtraction, the correction voltage is inverted to the positive side, and is added to the first detection voltage. Accordingly, the noise superposed on the first detection voltage and the noise superposed on the second detection voltage are canceled with each other, and the differential voltage has a waveform having a voltage value twice that of the first detection voltage, as shown in FIG. 12D.

The control circuit 3 calculates the capacitance in each element part, based on the differential voltage generated in this manner. Specifically, the control circuit 3 acquires, as the voltage value according to the capacitance in the element part serving as the detection target, a value obtained by multiplying, by ½, the voltage value (e.g., V3) of the differential voltage at the detection timing (e.g., time t11) of the capacitance. Further, the control circuit 3 calculates the capacitance in the element part, based on the acquired voltage value and the resistance value of the resistor 22 of the first detection circuit 20. Then, the control circuit 3 acquires the load applied to the element part, based on the calculated capacitance.

The method for acquiring the differential voltage shown in FIG. 12D is not limited to the method described above. For example, instead of the correction voltage, a voltage may be calculated by inverting the second detection voltage between the ground and the voltage VCC, and this voltage may be added to the first detection voltage, thereby acquiring the differential voltage.

In FIGS. 12A to 12D, for convenience of description, with respect to all of the preparation period, the detection period, and the discharge period, the waveforms of the first detection voltage, the second detection voltage, the correction voltage, and the differential voltage are shown. However, the control circuit 3 need not necessarily generate the differential voltage with respect to all of the periods, and may generate the differential voltage at least at the detection timing of the capacitance.

For example, the control circuit 3 may generate the differential voltage only at the detection timing of the capacitance. In this case, the control circuit 3 calculates a voltage value of the correction voltage by subtracting the voltage VCC from the voltage value of the second detection voltage at the detection timing (e.g., time t11) of the capacitance, and subtracts the calculated voltage value from the voltage value of the first detection voltage at the detection timing (e.g., time t11), thereby acquiring the voltage value of the differential voltage at the detection timing (e.g., time t11). Then, the control circuit 3 acquires, as the voltage value according to the capacitance in the element part serving as the detection target, a value obtained by multiplying, by ½, the acquired voltage value of the differential voltage, and further, calculates the capacitance in the element part, based on the acquired voltage value and the resistance value of the resistor 22 of the first detection circuit 20. The control circuit 3 acquires the load applied to the element part, based on the capacitance calculated in this manner.

### Effects of the Embodiment

According to the present embodiment, the following effects are exhibited.

As shown in FIG. 5, the load detecting device 4 includes: the first detection circuit 20 which performs charging of a predetermined voltage (VCC) and discharging of a charged voltage with respect to one electrode (the electrically-conductive member 13a of the conductor wire 13) of an element part, and which outputs a voltage (the first detection voltage) of the element part in a charge period (the detection period T12); and the second detection circuit 30 which, in parallel with the charging and discharging in the first detection circuit 20, performs discharging from the predetermined voltage (VCC) and charging of the predetermined voltage (VCC) with respect to the other electrode (the electrically-conductive elastic body 12) of the element part, and which outputs a voltage of the element part in a discharge period (the detection period T12). The control circuit 3, as shown in FIG. 12A to FIG. 12D, detects the capacitance in the element part, based on a differential voltage obtained by adding a voltage obtained by inverting the second detection voltage outputted from the second detection circuit 30 between the predetermined voltage (VCC) and the ground, to the first detection voltage outputted from the first detection circuit 20. Accordingly, noise superposed on the first detection voltage and noise superposed on the second detection voltage are canceled with each other, and in the differential voltage, noise is suppressed as shown in FIG. 12D. Therefore, based on this differential voltage, the capacitance according to the load on the element part can be accurately detected, and, as a result, the load applied to each element part can be accurately detected.

As shown in FIGS. 3A, 3B and FIG. 4, the element part A11 to A33 includes the electrically-conductive elastic body 12, the electrically-conductive member 13a having a linear shape, and the dielectric body 13b present between the electrically-conductive elastic body 12 and the electrically-conductive member 13a. As shown in FIG. 8 and FIGS. 10A, 10B, the first detection circuit 20 outputs the first detection voltage in the detection period T12 (charge period) with respect to one of the electrically-conductive elastic body 12 and the electrically-conductive member 13a (the conductor wire 13), and the second detection circuit 30 outputs the second detection voltage in the detection period T12 (discharge period) with respect to the other of the electrically-conductive elastic body 12 and the electrically-conductive member 13a (the conductor wire 13). Accordingly, the first detection voltage and the second detection voltage having the waveforms shown in FIGS. 10A, 10B are outputted from the first detection circuit 20 and the second detection circuit 30. Therefore, by performing the process shown in FIGS. 12A to 12D on these waveforms, it is possible to generate the differential voltage in which noises are canceled, and the capacitance according to the load in each element part can be accurately detected.

As shown in FIG. 8, in the load sensor 1, a plurality of the element parts are disposed, and the first detection circuit 20 and the second detection circuit 30 apply voltages (the voltages outputted from the equipotential generation parts 23, 33) for suppressing influence on change in the first detection voltage and the second detection voltage, to the electrically-conductive elastic bodies 12 and the electrically-conductive members 13a (the conductor wires 13) of other element parts (element parts included in the same row and the same column as the element part A11) that influence change in the first detection voltage and the second detection voltage in the element part A11 serving as the detection target. Accordingly, the first detection voltage and the second detection voltage according to the capacitance in the element part A11 serving as the detection target can be appropriately outputted from the first detection circuit 20 and the second detection circuit 30, respectively, and the capacitance in the element part A11 can be accurately detected.

### <Modification 1>

In the above embodiment, as shown in FIGS. 12A to 12D, the second detection voltage is used for suppression of noise. In contrast to this, in Modification 1, the second detection voltage is further used for detecting abnormality in the element part.

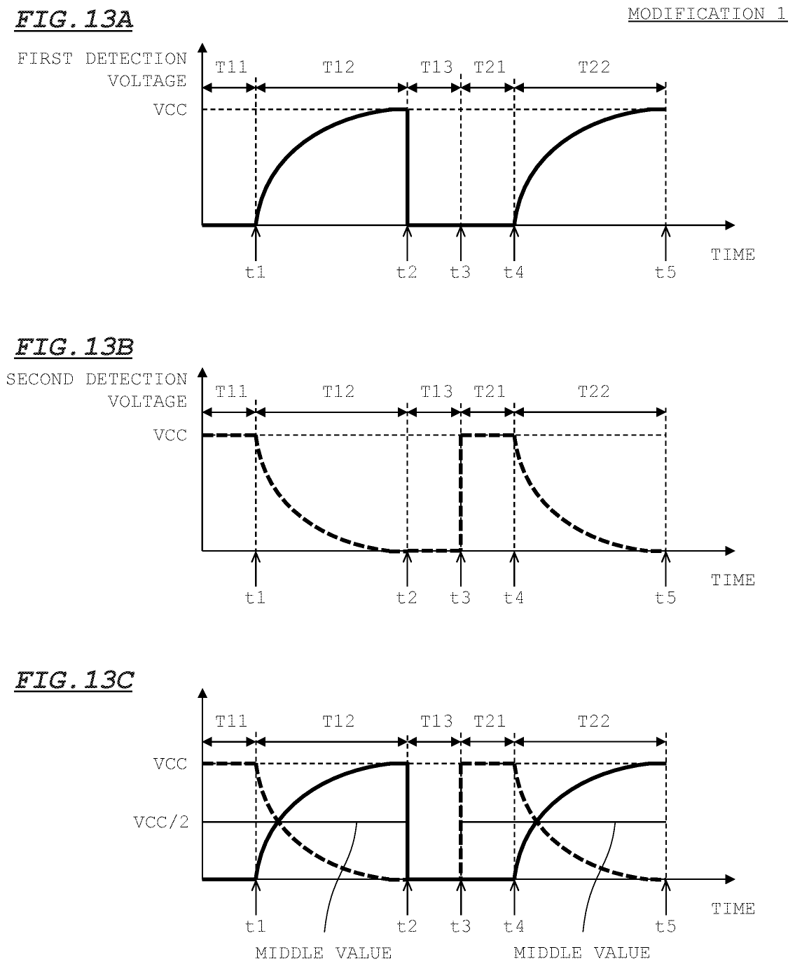

FIG. 13A to FIG. 13C are each a time chart showing a method for detecting abnormality in an element part by using the second detection voltage.

As described above, since the resistance value is the same between the resistor 22 of the first detection circuit 20 and the resistor 36 of the second detection circuit 30, the time constant during charging by the first detection circuit 20 with respect to the element part serving as the detection target and the time constant during discharging by the second detection circuit 30 with respect to the element part are substantially the same with each other. Therefore, as shown in FIGS. 13A, 13B, the waveforms of the first detection voltage and the second detection voltage have substantially symmetric shapes with respect to a straight line indicating the half value of the voltage VCC, excluding the discharge period T13.

Therefore, at each time excluding the discharge period T13, when the middle value between the first detection voltage and the second detection voltage is calculated, this middle value is a value near the half value of the voltage VCC as shown in FIG. 13C. However, for example, when a trouble has occurred in one or both of the electrically-conductive elastic body 12 and the electrically-conductive member 13a forming the electrodes of the element part, the symmetry of the waveforms of the first detection voltage and the second detection voltage with respect to the straight line indicating the half value of the voltage VCC is broken. In this case, the middle value between the first detection voltage and the second detection voltage deviates from the half value of the voltage VCC. Therefore, by detecting this deviation, it is possible to detect occurrence of any abnormality in the electrically-conductive elastic body 12 or the electrically-conductive member 13a.

In Modification 1, abnormality in an element part is detected based on this principle.

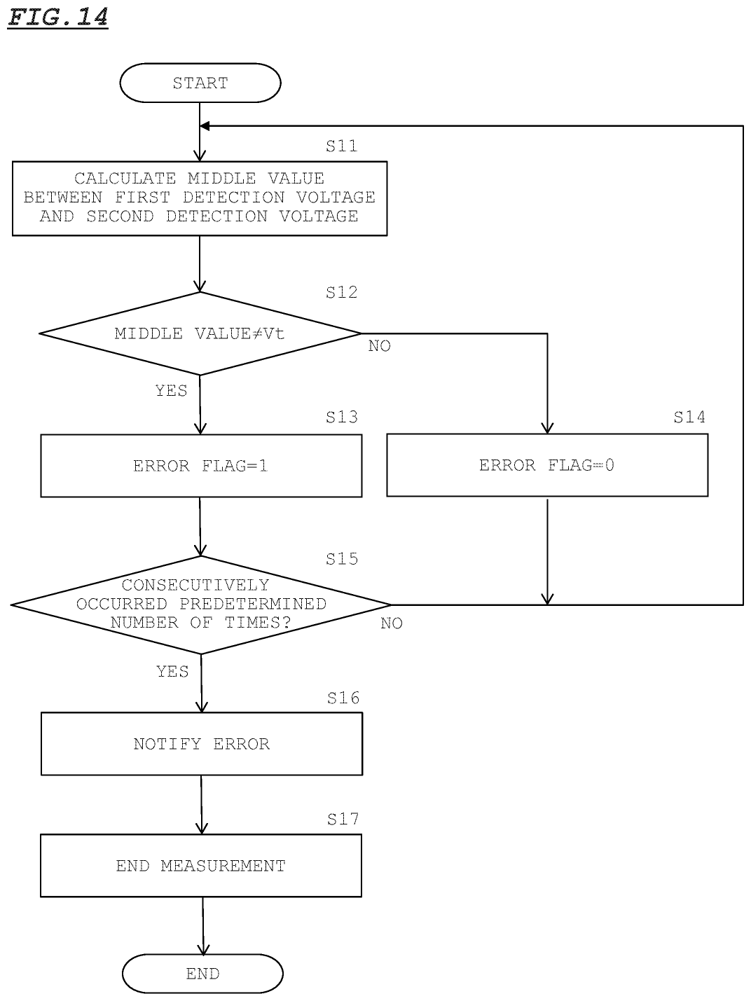

FIG. 14 is a flowchart showing a process for detecting abnormality in an element part.

At a detection timing set at a certain time interval in a period excluding the discharge period, the control circuit 3 calculates (S11) a middle value between the first detection voltage and the second detection voltage, and determines (S12) whether or not the middle value has deviated from a reference value Vt. Here, the reference value Vt is set to the half value of the voltage VCC. In step S12, when the difference between the middle value and the reference value Vt is within an allowable range in which the difference can occur during normal operation, the determination becomes NO, and when the difference is outside the allowable range, the determination becomes YES.

When the determination in step S12 is YES, the control circuit 3 sets an error flag to 1 (S13), and advances the process to step S15. On the other hand, when the determination in step S12 is NO, the control circuit 3 sets the error flag to 0 (S14), advances the process to step S11, and performs the process at the next detection timing.

In step S15, the control circuit 3 determines whether or not the state of the error flag being 1 has consecutively occurred a predetermined number of times. Here, the predetermined number of times is set to a number of times with which erroneous determination due to noise can be prevented. That is, the predetermined number of times is set so as to correspond to a period longer than a presumable period of noise, such that, when the middle value has sporadically deviated from the reference value Vt due to noise, this deviation is not determined as abnormality in the element part.

When the determination in step S15 is NO, the control circuit 3 advances the process to step S11 and performs the process at the next detection timing. On the other hand, when the determination in step S15 is YES, the control circuit 3 determines that abnormality has occurred in the element part (the electrically-conductive elastic body 12 or the electrically-conductive member 13a that cross each other in the element part) and transmits a signal indicating the determination, to a higher-order device (S16). Then, the control circuit 3 ends the load measurement process (S17).

With the configuration of Modification 1, as shown in FIGS. 13A to 13C, abnormality in the element part is detected based on whether or not the relationship between the first detection voltage and the second detection voltage is normal, that is, whether or not the waveforms of the first detection voltage and the second detection voltage are symmetric with respect to a straight line indicating the half value of the voltage VCC, excluding the discharge period. Accordingly, abnormality in the element part can be appropriately detected, and the load can be prevented from being continuously detected in an abnormal state.

As shown in FIG. 14, the control circuit 3 compares the middle value between the first detection voltage and the second detection voltage with the predetermined reference value Vt, to determine abnormality in the element part. Therefore, abnormality in the element part can be determined smoothly and in a simple manner.

The method for determining whether or not the relationship between the first detection voltage and the second detection voltage is normal is not limited to the above method. For example, when the difference between the first detection voltage and a voltage obtained by inverting the second detection voltage between the voltage VCC and the ground has exceeded a predetermined allowable range near 0, excluding the discharge period, it may be determined that the relationship between the first detection voltage and the second detection voltage has become abnormal.

### <Modification 2>

In the above embodiment, the capacitance in each element part is detected by using the differential voltage generated from the first detection voltage and the second detection voltage. In contrast to this, in Modification 2, a first mode in which the capacitance in each element part is detected through a process similar to the above embodiment and a second mode in which the capacitance in each element part is detected from the first detection voltage by causing only the first detection circuit 20 out of the first detection circuit 20 and the second detection circuit 30 to operate, are switched in accordance with the state of noise superposed on the first detection voltage.

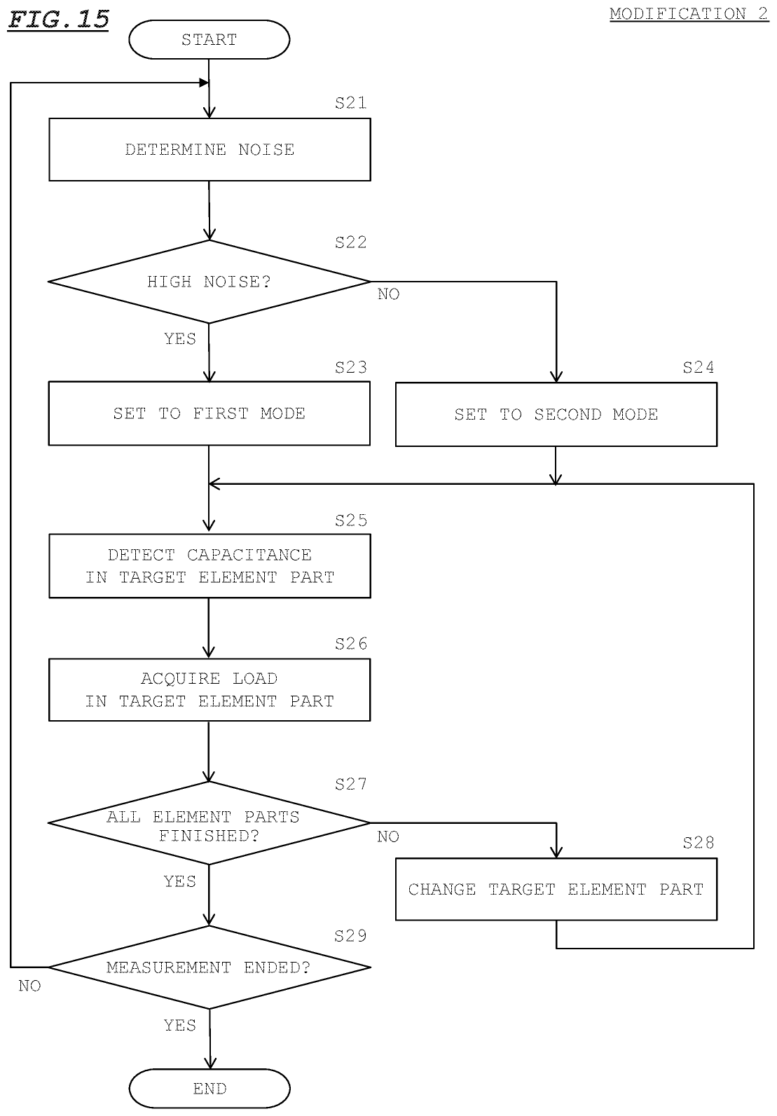

FIG. 15 is a flowchart showing a load detection process according to Modification 2.

The control circuit 3 determines whether or not the present status is a status where noise that influences detection of the capacitance is easily superposed on the first detection voltage (S21).

The determination in step S21 is performed by using an element part (e.g., the element part A11) to serve as the detection target first out of the element parts disposed in the load sensor 1, for example. With respect to this element part, the control circuit 3 causes only the first detection circuit 20 to operate, to perform a dummy process of one cycle (the preparation period, the detection period, the discharge period). Then, based on the state of the first detection voltage outputted from the first detection circuit 20 in the discharge period of the dummy process, the control circuit 3 determines the present status of noise.

That is, when noise is superposed on the first detection voltage in the discharge period, the first detection voltage, in the discharge period, which is originally at a zero level varies in accordance with the noise. The control circuit 3 acquires a voltage value a plurality of times (e.g., several tens of times) from the first detection voltage in the discharge period, and based on the acquired voltage value, determines whether or not the present status is a status where high noise is easily superposed on the first detection voltage.

For example, the control circuit 3 calculates the average value of voltage values of the first detection voltage acquired in the discharge period, and when this average value exceeds a predetermined threshold, determines that the present status is a status where high noise is easily superposed on the first detection voltage. Alternatively, when the number of voltage values, out of these voltage values, that exceed a predetermined threshold exceeds a threshold number, the control circuit 3 determines that the present status is a status where high noise is easily superposed on the first detection voltage. Alternatively, when the maximum value of the above voltage values exceeds a predetermined threshold, the control circuit 3 determines that the present status is a status where high noise is easily superposed on the first detection voltage.

In step S21, for example, based on one or a combination of these determination methods, the control circuit 3 determines whether or not the present status is a status where high noise is easily superposed on the first detection voltage.

In a case where any one of the determination methods is used, when, according to the determination method, the present status is a status where high noise is easily superposed on the first detection voltage, the control circuit 3 sets the determination in step S22 subsequent to step S21 to YES, and sets the determination in step S22 to NO in the other cases.

In a case where a plurality of these determination methods are used in combination, when, for example, according to at least one determination method, the present status is a status where high noise is easily superposed on the first detection voltage, the control circuit 3 sets the determination in step S22 to YES, and sets the determination in step S22 to NO in the other cases.

In this manner, through the dummy process using one element part, the control circuit 3 determines whether or not the present status is a status where high noise is easily superposed on the first detection voltage (S22). Then, when the present status is a status where high noise is easily superposed on the first detection voltage (S22: YES), the control circuit 3 sets the mode of the load detection to the first mode (S23), and when the present status is not a status where high noise is easily superposed on the first detection voltage (S22: NO), sets the mode of the load detection to the second mode (S24).

When the first mode has been set, the control circuit 3 causes, similar to the above embodiment, the first detection circuit 20 and the second detection circuit 30 to operate, to detect the capacitance in the element part serving as the detection target, based on the differential voltage. On the other hand, when the second mode has been set, the control circuit 3 causes only the first detection circuit 20 out of the first detection circuit 20 and the second detection circuit 30 to operate, to detect the capacitance in the element part serving as the detection target, based on the first detection voltage.

In the process according to the second mode, for example, as shown in FIG. 10A, the capacitance in the element part serving as the detection target is calculated based on the voltage value V1 of the first detection voltage at the time point after elapse of the certain time period ΔT from the start of the detection period, and the resistance value of the resistor 22 of the first detection circuit 20.

In accordance with the mode set in this manner, the control circuit 3 performs a detection process of the capacitance with respect to an element part (e.g., the element part A11) to serve as the detection target first (S25). Further, based on the detected capacitance, the control circuit 3 acquires the load in the element part serving as the detection target (S26). Then, the control circuit 3 determines whether or not detection of the capacitance and acquisition of the load have been performed with respect to all the element parts disposed in the load sensor 1 (S27). When the determination in step S27 is NO, the control circuit 3 changes the element part serving as the detection target to the next element part (e.g., element part A12) (S28), and performs the processes of step S25 and thereafter with respect to this element part. In this case as well, the mode (the first mode or the second mode) set through the dummy process is maintained.

Then, having performed detection of the capacitance and acquisition of the load with respect to all the element parts disposed in the load sensor 1 (S27: YES), the control circuit 3 determines whether or not the load measurement process has ended (S29). When the load measurement process has not ended (S29: NO), the control circuit 3 returns the process to step S21, and executes similar processes. Until the load measurement ends (S29: NO), the control circuit 3 repeatedly executes the processes of step S21 to S28. Then, when the load measurement has ended (S29: YES), the control circuit 3 ends the process in FIG. 15.

With the configuration of Modification 2, based on the status of noise superposed on the first detection voltage, either one of the first mode and the second mode is selectively executed. That is, when the present status is a status where high noise is easily superposed on the first detection voltage (S22: YES), the first mode in which the capacitance and the load in each element part are detected by causing the first detection circuit 20 and the second detection circuit 30 to operate, is executed. When the present status is not a status where high noise is easily superposed on the first detection voltage (S22: NO), the second mode in which the capacitance and the load in each element part are detected by causing only the first detection circuit 20 to operate, is executed. Accordingly, while power consumption of the load detecting device 4 is suppressed, the load in each element part can be appropriately detected.

### <Other Modifications>

In the above embodiment, the first detection circuit 20 performs charging and discharging with respect to the electrically-conductive member 13a being one electrode of the element part, and the second detection circuit 30 performs charging and discharging with respect to the electrically-conductive elastic body 12 being the other electrode of the element part. However, the detection circuit 2 may be configured such that the first detection circuit 20 performs charging and discharging with respect to the electrically-conductive elastic body 12, and the second detection circuit 30 performs charging and discharging with respect to the electrically-conductive member 13a.

In the above embodiment, nine element parts arranged in three columns and three rows are disposed in the load sensor 1. However, the disposition of the element parts in the load sensor 1 is not limited thereto. For example, a plurality of the element parts in numbers of columns and rows other than three columns and three rows may be disposed in the load sensor 1, or a plurality of the element parts may be disposed in only one row. Alternatively, only one element part may be disposed in the load sensor 1.

The configurations of the first detection circuit 20 and the second detection circuit 30 are not limited to the configurations shown in FIG. 5. The configurations of the first detection circuit 20 and the second detection circuit 30 can be changed as appropriate as long as, while charging and discharging with respect to one electrode of the element part and discharging and charging with respect to the other electrode of the element part are performed in parallel, the voltage of the one electrode during charging with respect to the electrode and the voltage of the other electrode during discharging with respect to the electrode can be respectively outputted.

Although the first switching circuit 40 and the second switching circuit 50 are implemented by the multiplexers 41, 51, the first switching circuit 40 and the second switching circuit 50 may be implemented by switching circuits other than multiplexers.

In the above embodiment, the conductor wire 13 is implemented by a covered copper wire. However, not limited thereto, the conductor wire 13 may be composed of: an electrically-conductive member having a linear shape formed from a substance other than copper; and a dielectric body covering the electrically-conductive member. The electrically-conductive member may be implemented by a twisted wire.

In the above embodiment, the electrically-conductive elastic bodies 12 are provided only on the face on the Z-axis positive side of the base member 11. However, the electrically-conductive elastic bodies may be provided also on the face on the z-axis negative side of the base member 15. In this case, the electrically-conductive elastic bodies on the base member 15 side are configured similarly to the electrically-conductive elastic bodies 12 on the base member 11 side, and are disposed so as to be superposed on the electrically-conductive elastic bodies 12, in a plan view, with the conductor wires 13 sandwiched therebetween. Then, cables drawn from the electrically-conductive elastic bodies on the base member 15 side are connected to the cables 12a drawn from the electrically-conductive elastic bodies 12 opposed in the Z-axis direction. When the electrically-conductive elastic bodies are provided above and below the conductor wires 13 like this, change in the capacitance in each element part becomes substantially twice in accordance with the upper and lower electrically-conductive elastic bodies. Therefore, the detection sensitivity of the load on the element part can be enhanced.

In the above embodiment, the dielectric body 13b is formed on the electrically-conductive member 13a so as to cover the outer periphery of the electrically-conductive member 13a. However, instead of this, the dielectric body 13b may be formed on the upper face of the electrically-conductive elastic body 12. In this case, in accordance with application of a load, the electrically-conductive member 13a sinks in and is wrapped by the electrically-conductive elastic body 12 and the dielectric body 13b, and the contact area between the electrically-conductive member 13a and the electrically-conductive elastic body 12 changes. Accordingly, similar to the above embodiment, the load applied to the element part can be detected.

In the above embodiment, each element part is formed by the electrically-conductive elastic body 12 and the conductor wire 13 crossing each other. However, the configuration of the element part is not limited thereto. For example, the element part may be formed by a hemisphere-shaped electrically-conductive elastic body and a flat plate-shaped electrode sandwiching a dielectric body. In this case, the dielectric body may be formed on the surface of the electrode opposed to the electrically-conductive elastic body, or may be formed on the surface of the hemisphere-shaped electrically-conductive elastic body.

In Modification 1, abnormality in the element part is determined through comparison between the middle value and the reference value in a period excluding the discharge period. However, the period in which the middle value and the reference value are compared in order to determine abnormality in the element part is not limited thereto. For example, abnormality in the element part may be determined through comparison between the middle value and the reference value only in the detection period.

In Modification 2, the status of noise is determined through the dummy process with respect to one element part. However, without performing the dummy process, the status of noise may be determined based on the first detection voltage during actual operation. For example, at a predetermined determination timing during actual operation, the first detection voltage in the discharge period is referred to, and based on the change state in the first detection voltage referred to, the status of noise at that time may be determined. In this case, either one of the first mode and the second mode is selectively set in accordance with the determined status of the noise, and then, the capacitance in each element part is detected in the set mode until the mode is reset at the next determination timing.

In Modification 2, detection of the capacitance in the second mode is performed by using the first detection voltage. However, detection of the capacitance in the second mode may be performed by using the second detection voltage. In this case, in the second mode, the capacitance in the element part is detected from the second detection voltage by causing only the second detection circuit out of the first detection circuit and the second detection circuit to operate.

In addition to the above, various modifications can be made as appropriate to the embodiment of the present invention without departing from the scope of the technical idea defined by the claims.

What is claimed is:

1. A load detecting device comprising:
a load sensor including an element part in which capacitance changes in accordance with a load;
a first detection circuit configured to perform charging of a predetermined voltage and discharging of a charged voltage with respect to one electrode of the element part, and output a voltage of the element part in a charge period;
a second detection circuit configured to, in parallel with the charging and discharging in the first detection circuit, perform discharging from the predetermined voltage and charging of the predetermined voltage with respect to another electrode of the element part, and output a voltage of the element part in a discharge period; and
a control circuit configured to detect the capacitance, based on a differential voltage obtained by adding a voltage obtained by inverting a second detection voltage outputted from the second detection circuit between the predetermined voltage and a ground, to a first detection voltage outputted from the first detection circuit.

2. The load detecting device according to claim 1, wherein
the element part includes an electrically-conductive elastic body, an electrically-conductive member having a linear shape, and a dielectric body present between the electrically-conductive elastic body and the electrically-conductive member,
the first detection circuit outputs the first detection voltage in the charge period with respect to one of the electrically-conductive elastic body and the electrically-conductive member, and
the second detection circuit outputs the second detection voltage in the discharge period with respect to another of the electrically-conductive elastic body and the electrically-conductive member.

3. The load detecting device according to claim 2, wherein
a plurality of the element parts are disposed, and
the first detection circuit and the second detection circuit apply voltages for suppressing influence on change in the first detection voltage and the second detection voltage, to the electrically-conductive elastic body and the electrically-conductive member of another of the element parts that influences change in the first detection voltage and the second detection voltage in the element part serving as a detection target.

4. The load detecting device according to claim 1, wherein
the control circuit determines abnormality in the element part, based on whether or not a relationship between the first detection voltage and the second detection voltage is normal.

5. The load detecting device according to claim 4, wherein
the control circuit determines abnormality in the element part by comparing a middle value between the first detection voltage and the second detection voltage with a predetermined reference value.

6. The load detecting device according to claim 1, wherein
the control circuit
includes a first mode in which capacitance in the element part is detected based on the differential voltage, and a second mode in which capacitance in the element part is detected from the first detection voltage by causing only the first detection circuit out of the first detection circuit and the second detection circuit to operate, and
determines a status of noise superposed on the first detection voltage, and based on a determination result thereof, selectively executes either one of the first mode and the second mode.
